(19) United States
(12) Patent Application Publication
(10) Pub. No.: US 2009/0071544 A1
(43) Pub. Date: Mar. 19, 2009

(54) FLUID CONDITIONING AND MIXING APPARATUS AND METHOD FOR USING SAME

(75) Inventors: MARK SERAFIN, Apple Valley, MN (US); RICHARD D. OLMSTED, VADNAIS HEIGHTS, MN (US)

Correspondence Address: MCKEE, VOORHEES & SEASE, P.L.C., 801 GRAND AVENUE, SUITE 3200, DES MOINES, IA, 50309-2721, US

(73) Assignee: VEK NANOTECHNOLOGIES, INC., Apple Valley, MN (US)

(21) Appl. No.: 11/855,579

(22) Filed: Sep. 14, 2007

(51) Int. Cl. G05D 11/02; F17D 3/00

(52) U.S. Cl. 137/88; 137/3

(57) ABSTRACT

The invention includes a high pressure fluid processing device for shearing particles in a fluid mixture. The fluid processing device makes use of a first annular flow path that is directed toward a second annular flow path. The two annular flow paths flow toward one another through a bore in a cylinder and meet one another within the cylinder. The pressure fluid processing device includes two rods that are spaced apart from one another across an impingement zone.

### BACKGROUND OF THE INVENTION

This invention relates to a fluid conditioning and mixing apparatus and method for using same.

Creation and processing of hard, non-compliant particles, or units of microstructure, in a fluid mixture is desirable for a variety of industrial processes including the preparation of inks, paints, CMP slurries, emulsions, abrasive coatings, and the like. In addition, fluid mixtures of hard particles are used extensively in the coating of magnetic media, such as, magnetic disks, magnetic tape or other magnetic media used for data storage. For magnetic media, the mixture may contain magnetic particles and a polymeric binder carried in a solvent. The coating process involves application of the mixture to a substrate, followed by a drying process to remove the solvent.

For high density magnetic media and other industrial processes, the size and uniformity of the various particles or microstructure is important. To produce particles or microstructure in a desired size range, industrial fluid processing techniques make use of one or more fluid processing devices. A fluid processing device processes the fluid mixture in a manner that subjects particles or other units of microstructure in the mixture to intense energy dissipation through the generation of a combination of intense shear and extensional forces. In this manner, particles in the fluid mixture can be broken down into smaller sized particles.

U.S. Pat. No. 6,923,213 shows a prior art processing apparatus designated in FIG. 7 of the present application by the numeral 10. Apparatus 10 includes a housing 12 and a common entrance 14. Off of common entrance 14 are two opposed conduits 16, 18, which extend downwardly and are terminated in plugs 20, 22. A horizontal bore 24 extends through housing 12 transversely to common entrance 14. A first gland 26 is inserted into one end of the horizontal bore 24, and a second gland 28 is inserted into the opposite end of horizontal bore 24. A first gland bore 30 extends vertically through the first gland 26, and a second gland bore 32 extends vertically through the second gland 28. Vertical gland bores 30, 32, are registered with the conduits 16, 18. A first outer seal 34 and a second inner seal 36 are positioned opposite first gland bore 30. The first outer seal 34 provides sealing engagement between housing 12 and first gland 26 and prevents fluid from bypassing through gland 26. The second seal 36 provides sealing engagement between housing 12 and the inner portion of gland 26, thereby forcing fluid through an annular flow path designated by arrows 46. Similarly, a third outer seal 38 and a fourth inner seal 40 are positioned on opposite sides of gland bore 32, thereby forcing fluid through annular flow passageway designated by the arrows 48. A first gland shaft 42 and a second gland shaft 44 extend centrally from the first and second glands 26, 28, respectively.

A first outer cylindrical member 50 is positioned within bore 24 and a second outer cylindrical member 52 is also positioned within bore 24. Cylindrical members 50, 52 can move horizontally within bore 24. Provided within outer first cylinder member 50 is a first inner cylinder member 54 and provided within second outer cylinder member 52 is a second inner cylinder member 56. Extending through first inner cylinder member 54 is a first cylinder bore 58, and extending through a second inner cylinder member 56 is a second cylindrical bore 60. An impingement zone 62 is provided centrally between the spaced apart first and second inner and outer cylinders 50, 52, 54, and 56.

Extending within the cylinder bores 58, 60 is a single rod 64 which also spans the impingement zone 62. Rod 64 is free floating, that is, it can move both upwardly and downwardly within the bores 58, 60, and it also can move horizontally. A single outlet 66 is provided in communication with impingement zone 62.

The structure described above utilizes a singular rod 64 which extends across the impingement zone 62. As a result, the rod 64 intrudes into the impingement zone 62 and partially blocks the fluid entering the impingement zone 62.

Furthermore, the rod 64 is free floating. That is, it is free to move upwardly or downwardly at its opposite ends and is also free to move laterally along its longitudinal axis. Consequently, the annular spaces may vary due to the upper or lower movement, and furthermore, the velocity of the fluid passing therethrough may vary.

Also there is an outer cylinder 50, 52 and an inner cylinder 58, 60. The combination of these cylinders 50, 52 and 58, 60 into one is desirable.

Therefore, a primary object of the present invention is the provision of an improvement over the prior art described above.

A further object of the present invention is the provision of first and second rods which are inserted within the cylinder, and which are spaced apart across the impingement zone 62.

A further object of the present invention is the provision of first and second rods that are fixed within the cylinder bore 58, so as to provide fixed annular spaces around which the fluid may travel.

A further object of the present invention is the provision of a simplified version of the cylinder, utilizing a single part rather than two parts as in the prior art device.

Another object of the present invention is the provision of an impingement zone and outlet wherein the dimensions are fixed.

A further object of the present invention is the provision of a processing device wherein the parts are economical to manufacture, durable in use, and efficient in operation.

### BRIEF SUMMARY OF THE INVENTION

The foregoing objects may be achieved by a conditioning and mixing device for fluid flow comprising a cylinder having a bore extending between first and second bore ends and a cylinder opening in communication with the bore between the first and second bore ends. A first rod is positioned within the bore between the cylinder opening and the first bore end, the first rod having an outer diameter spaced in an inward radial direction from the first bore to create a first fluid flow stream. A second rod is positioned within the bore between the cylinder opening and the other of the second bore end. The second rod has an outer diameter spaced in an inward radial direction from the second bore to create a second fluid flow stream. A pump is connected to the first bore end for delivering the first fluid stream to the first bore end and is connected to the second bore end for delivering the second fluid stream to the second bore end, whereby the first and second fluid streams will pass outwardly through the cylinder opening. An outlet is connected to the cylinder opening for permitting and exiting of a combined fluid flow from the first and second fluid streams.

According to another feature of the present invention, the first and second rods are fixed within the bore.

According to another feature of the present invention, the first and second rods are centrally fixed within the bore to create first and second annular flow paths respectively.

According to another feature of the present invention, the first and second annular flow paths have annular spaces between 0.300 inches and 0.100 inches.

According to another feature of the present invention, the first rod includes a first intermediate rod end adjacent the cylinder opening. The second rod has a second intermediate rod end adjacent the cylinder opening. The first and second intermediate rod ends are spaced apart from one another to create an impingement zone therebetween. The outlet is connected to the impingement zone.

According to another feature of the present invention, a first gland and a second gland protrude within the first and second ends of the bore respectively. The first and second rods are respectively attached to the first and second glands to fix the first and second rods within the bore.

According to another feature of the present invention, the impingement or mixing zone includes cross-sectional area equal or greater than the first and second cross-sectional areas of the bore.

According to another feature of the present invention, the first and second bore ends are positioned to direct fluid in first and second directions opposite to one another and the impingement or mixing zone is positioned to cause the first and second fluid streams to collide and mix with one another.

A method for using the present invention comprises taking a housing having a bore extending therethrough. The bore includes a first end and a second end and the housing includes a central opening in communication with the bore between the first and second bore ends. A first fluid stream is introduced into the first end of the bore. A second fluid stream is introduced into the second end of the bore. A first rod is placed between the first end and the central opening and a second rod is placed in the bore between the second end and the opening. The first and second rods are positioned in spaced relation to one another within the bore so that a mixing zone or impingement zone is formed in the space between the first and second rods. The first and second fluid streams are removed from the central opening of the bore.

### BRIEF DESCRIPTION OF THE DRAWINGS

FIG. 1 is a sectional view of the present invention.

FIG. 2 is a block diagram showing the steps of the present invention.

FIG. 3 is an exploded perspective view of a modified form of the invention showing the cylinders, the rods within the cylinders, and the glands fixed into the opposite ends of the bore.

FIG. 4 is an exploded perspective view of the present invention shown in FIG. 1 showing the cylinders, rods within the cylinders and glands fixed into the opposite ends of the bore.

FIG. 5 is a sectional view taken along line 5-5 of FIG. 1.

FIG. 6 is a sectional view taken along line 6-6 of FIG. 1.

FIG. 7 is a view of a prior art device.

### DETAILED DESCRIPTION OF THE PREFERRED EMBODIMENT

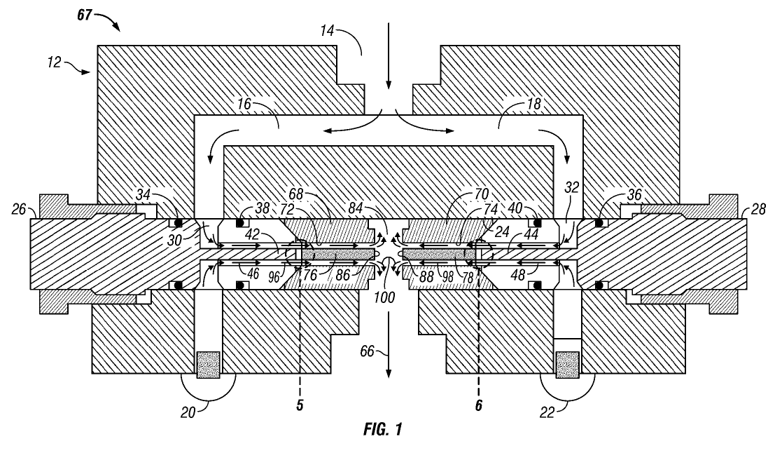

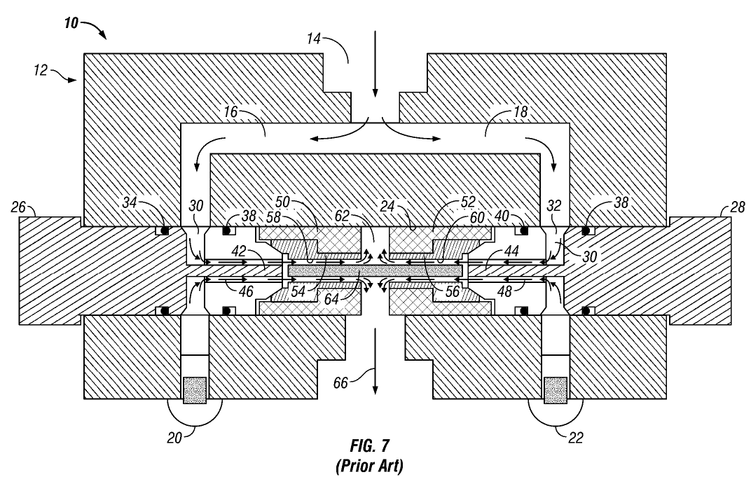

The corresponding numerals of FIG. 7 are reproduced in FIG. 1. A first cylinder member 68 is positioned within the horizontal bore 24 of the housing 12, and a second cylinder member 70 is positioned within bore 24. A first cylinder bore 72 extends horizontally through the first cylinder member and a second cylinder bore 74 extends through the second cylinder member 70. A first rod 76 is positioned within the first cylinder bore 72 and a second rod 78 is positioned within the second cylinder bore 74.

Referring to FIGS. 5 and 6, the ends of the rods 76, 78 are shown. Rod 76 is attached to first gland shaft 42 by means of a rod end 79 that is press fitted into gland shaft 42 and an adhesive or other attachment material may be used to further attach first rod 76 to first gland shaft 42. Second rod 78 is attached to second gland shaft 44 by means of a second rod end 81 that is press fitted into second gland shaft 44 and an adhesive or other attachment material may be used to further attach second rod 78 to second gland shaft 44. It should be noted that the first and second annular gland passageways 46, 48 are continuations of, but expansions of the sizes of the outer peripheral surfaces of first rods 76, 78 and the first and second inner radial bores 72, 74 of the cylinders 68, 70.

An impingement or mixing zone 84 is between the opposite ends of first and second rods 74, 76. This impingement zone utilizes a complete opening between the first and second rods 76, 78. This is to be contrasted with FIG. 7 which shows a prior art device utilizing a single rod that extends across the impingement zone 62 rather than first and second rods 76, 78 which include intermediate or distal rod ends 86, 88 that are spaced apart from one another across the impingement zone 84. The annular spaces 46, 48, 72, 74 are less than 0.0060 inches in thickness.

Referring to FIG. 4, an exploded view of the glands 26 and the first and second cylinders 68, 70 are shown. The first and second rods 76, 78 are spaced apart an impingement zone 84.

There are several structural features which are different between the device shown in FIG. 1 and the device shown in FIG. 7. The impingement zone 84 (FIG. 1) is spaced apart from the intermediate ends 86, 88 of the rods 76, 78. Furthermore, the first and second rods 76, 78 are attached to the first and second gland shafts 42, 44, and therefore they are fixed within the bore between the first and second bores 72, 74. This provides continuous annular spaces 72, 74 for carrying the fluid in opposite directions as indicated by the arrows 96, 98. The result is a more constant velocity in the fluid path and also in the fixing of the first and second rods 76, 78 centrally within the location of the first and second bores 72, 74. Another feature which is different from the prior art device shown in FIG. 7 is that the impingement zone 84 includes a cross sectional area that is equal to or exceeds the first and second cylinder bores 72, 74 respectively. Another difference between FIG. 7 and FIG. 1 is that FIG. 7 shows outer cylinders 50, 52, and inner cylinders 58, 60. In contrast, FIG. 1 shows only single cylinders 68, 70.

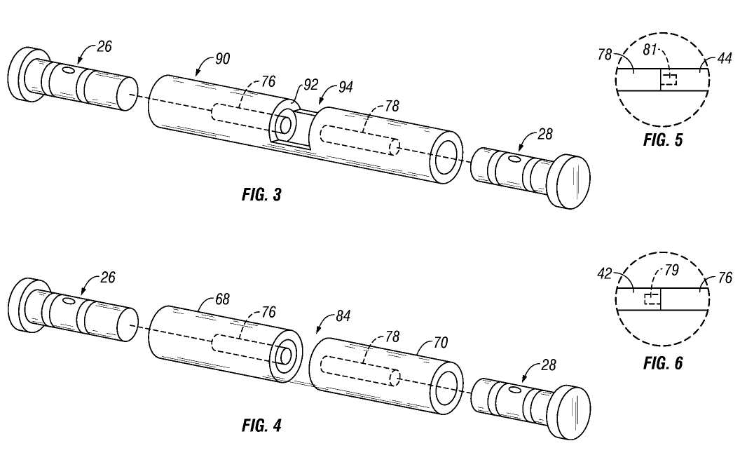

Referring to FIG. 3, a modified form of the invention is shown wherein a singular cylinder 90 is shown. The singular cylinder includes a partial slot 92 which further creates a modified impingement zone 94.

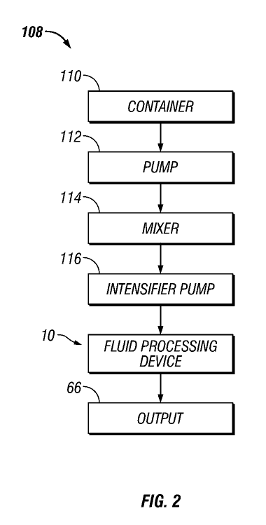

The fluid flow extends in opposite directions, and the arrows 100 refer to the opposite fluid streams impacting in the impingement areas 84, 94 so as to result in a breakdown of the particles or microstructure within the fluid. FIG. 2 shows a block diagram of an exemplary industrial fluid processing system 108. System 108 may include a processing device 10 with opposing annular flow paths as described herein. System 108 with fluid processing device 10 may be particularly useful in processing coating solutions having high concentrations of solids. For example, system 108 may be used to process coating solutions having solid particle contents of greater than approximately 1% by weight, although the invention is not limited in that respect. System 108 may also be used for other industrial processes including for example the preparation of inks, paints, abrasive coatings, CMP slurries, emulsions and the like.

Containers or vessels 110 stores one or more water or solvents, one or more collection of particles, and optionally other materials used to form a fluid mixture such as a coating solution, ink, paint, or the like. A mixer 112 mixes the materials and solvent from vessel 110. Mixer 112 may comprise a planetary mixer, a double planetary mixer, or the like. Additional materials may be added in stages. Accordingly, container 110 may not contain all of the ingredients of a final mixture. Moreover, in some embodiments, the fluid mixture may contain two or more mixed fluids, with or without other particles mixed in the fluids. The mixer 112 delivers the mixture to a pump 114 which in turn delivers the mixture to an intensifier pump 116.

One or more intensifier pumps 116 may be capable of generating approximately 100 to 40,000 psi (690 kPa to 280 MPa) of fluid pressure. Fluid processing device 10 as described herein may be capable of handling pressures to approximately 40,000 psi (280 MPa), greater than approximately 30,000 psi (207 MPa), greater than approximately 50,000 psi (345 MPa). Following pressurization by intensifier pump 116, the mixture is delivered to fluid processing device 10. The fluid processing device 10 is useful for the intimate mixing of the various components of the fluid mixture and in the reduction in size of the particulate or other microstructures within the fluid mixture. This is the result of the shear and extensional forces created by the collision or impingement of the fluid streams and the passing through the annular flow path within the processing device 10. Fluid processing device 10 causes shearing to reduce the size of the particles in the mixture. In other words, the fluid processing device 10 serves to break down the particles in the mixture into smaller sized particles and thereby produce a finally disbursed solution of particles having a desired size range. Heat exchangers (not shown) may be used to dissipate excess thermal energy generated in the mixture during processing and shearing.

A filtration element may be used to filter particles in the mixture. For example, the filtration element may comprise one or more porous membranes, mesh screens, or the like, to filter the mixture. The output of the filtration element may be then used for magnetic coating (in the case of magnetic media manufacturer) or other industrial processes. In some cases the output may be packaged and sold as in the case of inks, paints, dyes, or the like. A back pressure regulator (not shown) may be added down stream of the filtration element to help maintain constant pressure in system 108 and provide a return path to container 110 for the mixture.

The method of operation of fluid processing device 10 is as follows: fluid is introduced into entrance 14. It is then split into two conduits 16, 18, and descends to gland bores 30, 32. It then enters the gland passageways 46, 48 where it constitutes two fluid streams heading in opposite directions to one another. It passes around rods 76, 78, which form annular passageways 72, 74. Then it is directed toward the impingement zone 84, 94 where the fluid solutions contained therein are directed toward one another and encounter shear forces, resulting in a breakdown of microstructure. From the impingement zone 84 the fluid passes outwardly through outlet 66.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A conditioning and mixing device for fluid flow comprising;
a cylinder having bore extending between first and second bore ends and a cylinder opening in communication with the bore between the first and second bore ends;
a first rod positioned within the bore between the cylinder opening and the first bore end, the first rod being spaced inwardly with respect to the bore to create a first annular flow path between the bore and the first rod thereby creating a first fluid flow stream;
a second rod positioned within the bore between the cylinder opening and the other of the second bore end, the second rod being spaced inwardly from the bore to create a second annular flow path between the bore and the second rod, thereby creating a second fluid flow stream;
a pump connected to the first bore end and the second bore end for delivering the first fluid stream to the first bore end and for delivering the second fluid stream to the second bore end respectively whereby the first and second fluid streams will pass outwardly through the cylinder opening.
an outlet connected to the cylinder opening for permitting an exiting of a combined fluid flow from the first and second fluid streams.

2. The conditioning and mixing device of claim 1 wherein the first and second rods are fixed within the bore.

3. The conditioning and mixing device of claim 2 wherein the first and second rods are centrally fixed within the bore to create first and second annular flow paths, respectively.

4. The conditioning and mixing device of claim 1, wherein the first and second annular flow paths have annular spaces between 0.0060 inches or less.

5. The conditioning and mixing device of claim 1 wherein the first rod includes a first intermediate rod end adjacent the cylinder opening, the second rod having an intermediate rod end adjacent the cylinder opening, the first and second intermediate rod ends being spaced apart from one another to create an impingement zone there between, the outlet being connected to the impingement zone.

6. The conditioning and mixing device of claim 5 wherein the first and second rods are fixed within the bore.

7. The conditioning and mixing device of claim 6 wherein a first gland and a second gland block the first and second ends of the bore, respectively, and the first and second rods being respectively attached to the first and second glands to fix the first and second rods within the bore.

8. A conditioning and mixing device for a flow of fluid comprising:
a cylinder having bore extending between first and second bore ends and a cylinder opening in communication with the bore between the first and second bore ends;
the bore having a first annular cross-sectional area between the first bore and the cylinder opening and having a second annular cross-sectional area between the second bore end and the cylinder opening;
a mixing zone adjacent the cylinder opening;
a pump connected to the first bore end and the second bore end respectively for delivering a first fluid stream to the first bore end and for delivering a second fluid stream to the second bore end whereby the first and second fluid streams will pass into the mixing zone and outwardly through the cylinder opening.

9. A conditioning and mixing device according to claim 8 wherein the mixing zone includes a mixing zone cross-sectional area equal to or greater than the first and second cross-sectional areas.

10. A conditioning and mixing device according to claim 8 wherein a first rod is within the bore between the first bore end and the cylinder opening and a second rod is within the bore between the second bore end and the cylinder opening.

11. A conditioning and mixing device according to claim 8 wherein the mixing zone is adjacent the cylinder opening between the first and second rods.

12. A conditioning and mixing device according to claim 10 wherein the first and second rods are fixed within the bore.

13. A conditioning and mixing device according to claim 12 wherein a first gland and a second gland are mounted respectively to the first and second ends of the bore, and the first and second rods being affixed to the first and second glands, respectively.

14. The conditioning and mixing device of claim 8 wherein the first and second bore ends are positioned to direct fluid in first and second directions opposite to one another and the mixing zone being positioned to cause the first and second fluid streams to collide and mix with one another.

15. A conditioning and mixing device for a flow of fluid comprising:
a housing comprising an inlet for introducing the fluid into the housing, a first bore in communication with the inlet for receiving a first fluid stream, and a second bore in fluid communication with the inlet for receiving a second fluid stream;
the first and second bores each having first and second outlet ends adjacent one another and having first and second cross-sectional bore shapes, respectively;
a mixing zone between the first and second outlet ends of the first and second bores, the mixing zone having a mixing zone cross sectional shape that is registered with and is at least equal to the first and second cross sectional bore shapes;
an outlet connected to the mixing zone for delivering the first and second streams of fluid away from the mixing zone.

16. The mixing and conditioning device according to claim 15 wherein the first and second bores each comprise an annular passageway.

17. The mixing and conditioning device according to claim 16 wherein first and second rods are positioned within the first and second bores respectively.

18. The mixing and conditioning device according to claim 17 wherein the first and second rods are fixed within the first and second bores respectively.

19. A method for conditioning and mixing a fluid comprising:
taking a housing having a bore extending there through, the bore having a first end and a second end, the housing having a central opening in communication with the bore between the first and second bore ends;
introducing a first fluid stream into the first end of the bore;
introducing a second fluid stream into the second end of the bore;
placing a first rod in the bore between the first end and the central opening;
placing a second rod in the bore between the second end and the central opening;
positioning the first rod and the second rod in spaced relation to one another within the bore so that a mixing zone is formed in the space between the first and second rods;
removing the first and second fluid streams from the central opening of the bore.

20. The method according to claim 19 and further comprising fixing the first and second rods within the bore so as to create a first annular opening between the first rod and the bore, and creating a second annular opening between the second rod and the bore.
